(19) United States
(12) Patent Application Publication
(10) Pub. No.: US 2022/0207289 A1
(43) Pub. Date: Jun. 30, 2022

(54) DEVICE SELECTION APPARATUS, DATA SET SELECTION APPARATUS, METHOD FOR SELECTING DEVICE, AND PROGRAM

(71) Applicant: OMRON Corporation, Kyoto-shi, KYOTO (JP)

(72) Inventors: Tetsuji YAMATO, Yokohama-shi (JP); Taiji YOSHIKAWA, Kizu-shi (JP)

(73) Assignee: OMRON Corporation, Kyoto-shi, KYOTO (JP)

(21) Appl. No.: 16/961,713

(22) PCT Filed: Nov. 29, 2018
(86) PCT No.: PCT/JP2018/043925

§ 371 Date: Sep. 8, 2021

(30) Foreign Application Priority Data
Feb. 14, 2018 (JP) 2018-023613

(51) Int. Cl. G06K 9/62; G06F 16/907; G08C 17/02

(52) U.S. Cl. CPC G06K 9/6231; G08C 17/02; G06F 16/907; G06K 9/6256

(57) ABSTRACT

Provided are a device selection apparatus, a method for selecting a device, and a program by which a device for outputting input data to a processing module can be selected as appropriate in order to realize a virtual sensor having a desired function. The processing module is associated with first metadata indicating an attribute of learning data. The device is associated with second metadata indicating an attribute of data output by the device. The device selection apparatus includes a first acquisition unit, a second acquisition unit, and a selection unit. The first acquisition unit acquires first metadata. The second acquisition unit acquires second metadata associated with a plurality of devices. The selection unit selects a device for outputting input data to a processing module based on the first metadata and the second metadata.

### TECHNICAL FIELD

The present invention relates to a device selection apparatus, a data set selection apparatus, a method for selecting a device, and a program.

### RELATED ART

JP 2014-45242A (Patent Document 1) discloses a virtual sensor generation apparatus for generating a virtual sensor. A virtual sensor is generated in this virtual sensor generation apparatus as a result of detecting a real sensor that is present in a predetermined range and the detected real sensor being used (see Patent Document 1).

### RELATED ART DOCUMENTS

### Patent Documents

Patent Document 1: JP 2014-45242A

### SUMMARY OF THE INVENTION

### Problem to be Solved by the Invention

A virtual sensor such as that disclosed in Patent Document 1 above includes a real sensor (an example of a device) and a processing module, for example. The processing module is a trained model generated using a plurality of learning data, and generates output data, which is different from input data, by processing sensing data (an example of input data) output by the real sensor. When inappropriate data is input to such a processing module, the intended function of the trained model may not be attained, and as a result, the virtual sensor may not be able to perform its desired function.

The present invention was made to resolve such issues, and an object of the present invention is to provide a device selection apparatus, a method for selecting a device, and a program by which a device for outputting input data to a processing module can be selected as appropriate in order to realize a virtual sensor having a desired function.

Also, another object of the present invention is to provide a data set selection apparatus capable of appropriately selecting a data set to be input to a processing module in order to realize a virtual sensor having a desired function.

### Means for Solving the Problems

A device selection apparatus according to an aspect of the present invention is configured to select a device for outputting input data to a processing module. The processing module is a trained model generated using a plurality of learning data, and is configured to generate, based on at least one of the input data, output data that is different from the input data. The processing module is associated with first metadata indicating an attribute of the learning data. The device is associated with second metadata indicating an attribute of input data output by the device. The device selection apparatus includes a first acquisition unit, a second acquisition unit, and a selection unit. The first acquisition unit is configured to acquire the first metadata. The second acquisition unit is configured to acquire the second metadata associated with a plurality of devices. The selection unit is configured to select, from the plurality of devices, a device for outputting input data to the processing module based on the first metadata and the second metadata.

As described above, the processing module is a trained model generated using a plurality of learning data. A trained model assumes attributes of learning data, and thus does not always output a desired result if data with completely different attributes are input. In this device selection apparatus, when a device for outputting input data to the processing module is selected, first metadata indicating attributes of learning data and second metadata indicating attributes of input data output by the device are taken into account. Thus, this device selection apparatus can select a device as appropriate because the device is selected in consideration of the attributes of learning data.

Preferably, the device selection apparatus further includes a third acquisition unit. The third acquisition unit is configured to acquire one of a plurality of processing modules from a database in which the processing modules are stored. The first acquisition unit is configured to acquire first metadata associated with the processing module acquired by the third acquisition unit.

In the device selection apparatus, first metadata associated with the processing module acquired by the third acquisition unit is acquired by the first acquisition unit. Thus, according to the device selection apparatus, it is possible to refer to first metadata associated with an appropriate processing module when a device is selected.

Preferably, the third acquisition unit is configured to acquire the processing module from the database in accordance with a user instruction.

In this device selection apparatus, a processing module is acquired from a database in accordance with a user instruction. Thus, according to this device selection apparatus, a user can select a desired processing module.

Preferably, a device is a sensor. The input data is sensing data generated by the sensor.

Preferably, the processing module is configured to generate output data based on a plurality of input data.

Preferably, the processing module is configured to be capable of switching the device for outputting the input data to the processing module.

Preferably, a virtual sensor is formed by the processing module and the device for outputting the input data to the processing module.

Also, a data set selection apparatus according to another aspect of the present invention is configured to select a data set to be input to a processing module. The data set is constituted by a plurality of data. The processing module is a trained model generated using a plurality of learning data, and is configured to generate, based on at least one of the input data, output data that is different from input data. The processing module is associated with first metadata indicating attributes of learning data. The data set is associated with second metadata indicating an attribute of the data set. The data set selection apparatus includes a first acquisition unit, a second acquisition unit, and a selection unit. The first acquisition unit is configured to acquire the first metadata. The second acquisition unit is configured to acquire the second metadata associated with a plurality of data sets. The selection unit is configured to select, from the plurality of data sets, a data set to be input to the processing module based on the first metadata and the second metadata.

In this data set selection apparatus, when a data set to be input to the processing module is selected, first metadata indicating attributes of learning data and second metadata indicating attributes of the data set are taken into account. Thus, according to this data set selection apparatus, it is possible to select a data set as appropriate because a data set is selected in consideration of attributes of learning data.

### Effects of the Invention

According to the present invention, it is possible to provide a device selection apparatus, a method for selecting a device, and a program by which a device for outputting input data to a processing module can be selected as appropriate in order to realize a virtual sensor having a desired function.

Also, according to the present invention, it is possible to provide a data set selection apparatus capable of appropriately selecting a data set to be input to a processing module in order to realize a virtual sensor having a desired function.

### BRIEF DESCRIPTION OF THE DRAWINGS

FIG. 1 is a diagram illustrating an overview of a sensor selection apparatus.

FIG. 2 is a diagram showing an example of a sensor network system.

FIG. 3 is a diagram showing an example of a hardware configuration of a virtual sensor management sever.

FIG. 4 is a diagram showing an example of a processing module DB.

FIG. 5 is a diagram showing an example of a processing module-side metadata DB (first metadata DB).

FIG. 6 is a diagram showing an example of a relationship between software modules.

FIG. 7 is a diagram showing an example of a hardware configuration of an SDTM server.

FIG. 8 is a diagram showing an example of a sensor-side metadata DB.

FIG. 9 is a diagram showing an example of a detailed configuration of a sensor search module.

FIG. 10 is a diagram showing an example of a detailed configuration of a data flow control module.

FIG. 11 is a flowchart showing an example of an input sensor selection operation of a processing module.

### EMBODIMENTS OF THE INVENTION

Hereinafter, an embodiment (also referred to as “this embodiment” hereinafter) according to an aspect of the present invention will be described in detail with reference to the drawings. It should be noted that in the drawings, identical or corresponding portions have been assigned the same reference numerals, and their explanation is not repeated. Also, this embodiment disclosed below is an example of the present invention in all respects. Various modifications and changes can be made to this embodiment in the scope of the present invention. That is, when the present invention is implemented, a specific configuration according to an embodiment may be adopted as appropriate.

### 1. Overview

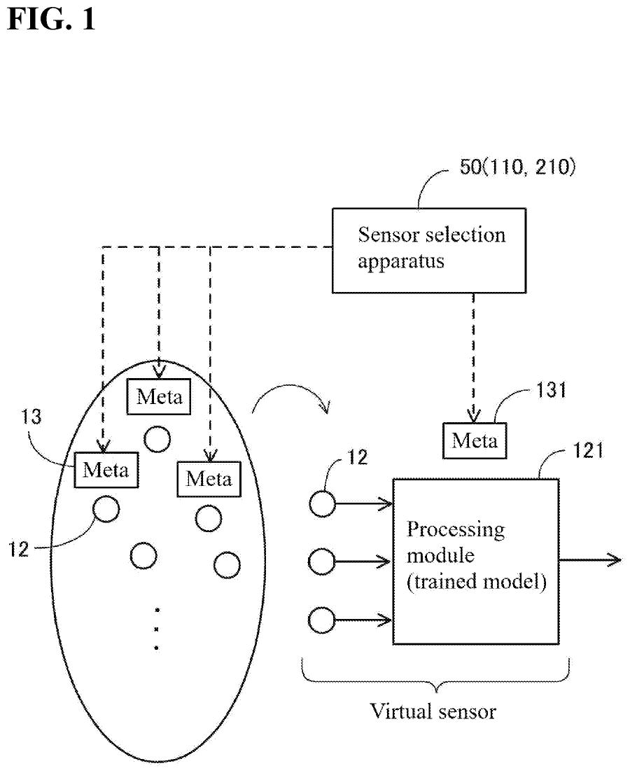

FIG. 1 is a diagram illustrating an overview of a sensor selection apparatus 50 (an example of a device selection apparatus) according to this embodiment. Referring to FIG. 1, a processing module 121 has a plurality of input ports, and sensing data (an example of input data) output by real sensors 12 (an example of a device) are input to the input ports. The processing module 121 is a trained model generated using a plurality of learning data, and is configured to generate, based on input data, output data that is different from the input data. That is, a so-called virtual sensor is formed by the processing module 121 and the real sensors 12 (input sensors) for outputting input data to the processing module 121. A virtual sensor is a sensor module for outputting, as sensing data, a result of observation of an object that is different from an object observed by an input sensor, based on sensing data generated as a result of the input sensor observing an object. The virtual sensor will be described later in detail.

A sensor selection apparatus 50 according to this embodiment is configured to select the real sensor 12 (also referred to as an “input sensor” hereinafter) for outputting input data to the processing module 121. If an inappropriate real sensor 12 (e.g., the real sensor 12 that outputs data with attributes that are completely different from attributes of learning data) is selected as an input sensor, the intended function of the processing module 121 (trained model) is not attained, and as a result, a situation may arise where the virtual sensor cannot perform its desired function.

The sensor selection apparatus 50 according to this embodiment is configured to select a real sensor 12 that is suitable as a sensor for inputting data to the processing module 121, from a plurality of real sensors 12 that can communicate via a network. Specifically, the processing module 121 is associated with processing module-side metadata (also referred to as “first metadata” hereinafter) 131. First metadata indicates attributes of learning data used to train the processing module 121. On the other hand, the real sensor 12 is associated with sensor-side metadata (also referred to as “second metadata” hereinafter) 13. Second metadata 13 indicates attributes of input data output by the corresponding real sensor 12. The sensor selection apparatus 50 is configured to select an input sensor from a plurality of real sensors 12 based on the first metadata 131 and second metadata 13.

In this manner, with the sensor selection apparatus 50, when an input sensor is selected, first metadata 131 indicating attributes of learning data and second metadata 13 indicating attributes of input data output by the real sensor 12 are taken into account. Thus, the sensor selection apparatus 50 can select an input sensor as appropriate because a real sensor 12 is selected in consideration of attributes of learning data.

### 2. Configuration

2-1. Overall configuration of system

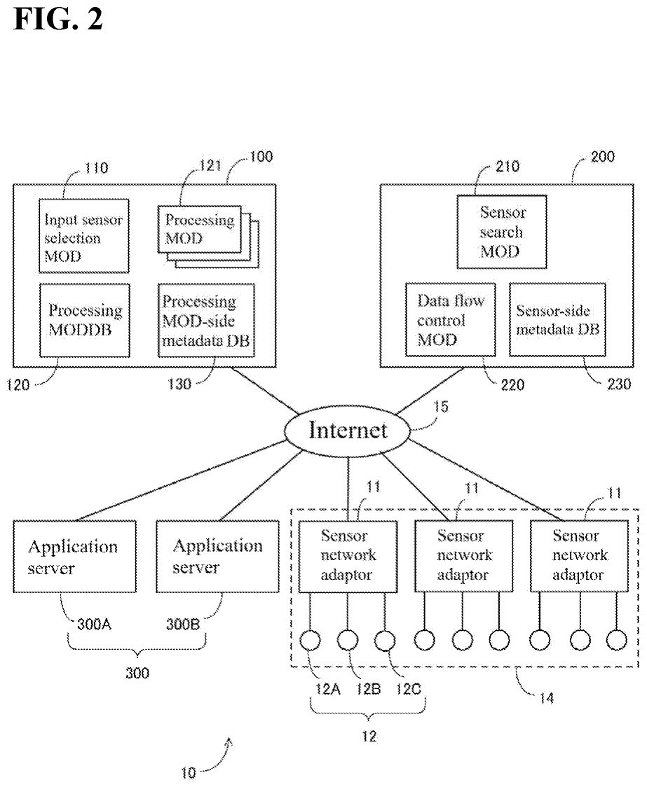

FIG. 2 is a diagram showing an example of a sensor network system 10 that includes the sensor selection apparatus 50 (FIG. 1) according to this embodiment. In the example shown in FIG. 2, the sensor network system 10 includes a sensor network unit 14, a virtual sensor management server 100, an SDTM (Sensing Data Trading Market) server 200, and an application server 300. Note that the sensor selection apparatus 50 is realized by the virtual sensor management server 100 and the SDTM server 200 in this embodiment.

The sensor network unit 14, the virtual sensor management server 100, the SDTM server 200, and the application server 300 are connected to each other to be capable of mutual communication via an Internet 15. Note that the number of constituent elements (the virtual sensor management server 100, the SDTM server 200, the application server 300, the sensor network adapter 11, the real sensors 12, and the like) included in the sensor network system 10 is not limited to the number thereof shown in FIG. 2.

Sensing data generated by a sensing device (e.g., real sensors and virtual sensors) can be distributed in the sensor network system 10. Sensing data generated by the real sensors 12 may be distributed to the virtual sensor management server 100, and sensing data generated by virtual sensors may be distributed to the application server 300, for example.

The sensor network unit 14 includes a plurality of sensor network adapters 11, for example. A plurality of real sensors 12 are respectively connected to the plurality of sensor network adapters 11, and the real sensors 12 are connected to the Internet 15 via the sensor network adapters 11.

The real sensors 12 are configured to obtain sensing data by observing an object. Examples of the real sensor 12 include an image sensor (a camera), a temperature sensor, a humidity sensor, an illuminance sensor, a force sensor, a sound sensor, an RFID (Radio Frequency IDentification) sensor, an infrared sensor, an attitude sensor, a rainfall sensor, a radiation sensor, and a gas sensor, and any types of sensor may be used as the real sensor. Also, the real sensor 12 is not necessarily fixed, and may be a mobile sensor such as a mobile phone, a smartphone, or a tablet. Also, each real sensor 12 is not necessarily constituted by a single sensing device, and may be constituted by a plurality of sensing devices. The real sensor 12 may also be installed for any purposes, and may also be installed for FA (Factory Automation) and production management in factories, urban traffic control, environment measurement such as weather measurement, healthcare, and crime prevention, for example.

Although the sensor network adapters 11 are arranged in separate (distant) portions and the real sensors 12 connected to the sensor network adapters 11 are arranged at the same (near) portions in the sensor network unit 14, for example, their arrangement locations are not limited thereto.

Application servers 300 (300A, 300B) are configured to execute applications that utilize sensing data, and are realized by general-purpose computers, for example. The application servers 300 acquire necessary sensing data via the Internet 15.

The virtual sensor management server 100 realizes a virtual sensor. A plurality of processing modules 121 and an input sensor selection module 110 are realized, and a processing module DB 120 and a processing module-side metadata DB 130 are managed in the virtual sensor management server 100. The plurality of processing modules 121 and the input sensor selection module 110 are software modules, for example.

The processing module 121 is a trained model generated using a plurality of learning data, includes at least one input port, and is configured to generate output data that is different from input data based on the input data that is input to the input port. The processing module 121 is capable of switching the real sensors 12 for outputting input data to an input portion as needed. If the real sensor 12 that is currently outputting input data to an input port fails, for example, the processing module 121 is capable of switching the input sensor to another real sensor 12.

The processing module 121 may also be configured to output data indicating the number of persons present in a room based on input data (sound data) output by a sound sensor arranged in the room, for example. In this case, the processing module 121 may also be generated through learning (machine learning) using a plurality of learning data as follows, for example. Note that it is possible to use, as machine learning, various known methods such as a neutral network, decision tree learning, association rule learning, and a Bayesian network. The plurality of learning data may also be training data that include sound data output by a sound sensor, and data (correct label) indicating the number of persons present in the room when sound data are output, for example. The processing module 121 becomes a trained model through learning using such a plurality of learning data, the trained model being capable of outputting data indicating the number of persons present in the room based on input sound data that is input, for example. Note that, in this case, a virtual sensor capable of detecting the number of persons in the room is realized by the processing module 121 and the real sensor 12 (sound sensor).

The input sensor selection module 110 is configured to execute processing for selecting a real sensor 12 for outputting input data to the processing module 121. Data output by the real sensor 12 selected by the input sensor selection module 110 is input to the processing module 121. Software modules and databases will be described later in detail.

The SDTM server 200 realizes the distribution of sensing data in the sensor network system 10. The sensor search module 210 and the data flow control module 220 are realized, and the sensor-side metadata DB 230 is managed in the SDTM server 200. The sensor search module 210 and the data flow control module 220 are software modules, for example.

The sensor search module 210 is configured to receive a request from the virtual sensor management server 100 (the input sensor selection module 110) and search for candidates for an input sensor (also referred to as “input sensor candidates” hereinafter) for inputting data to the processing module 121. The data flow control module 220 is configured to receive a request from the virtual sensor management server 100 (the input sensor selection module 110) and control distribution of sensing data from the real sensors 12 to the processing modules 121 and the like. Software modules and databases will be described later in detail.

### 2-2. Hardware Configuration of Virtual Sensor Management Server

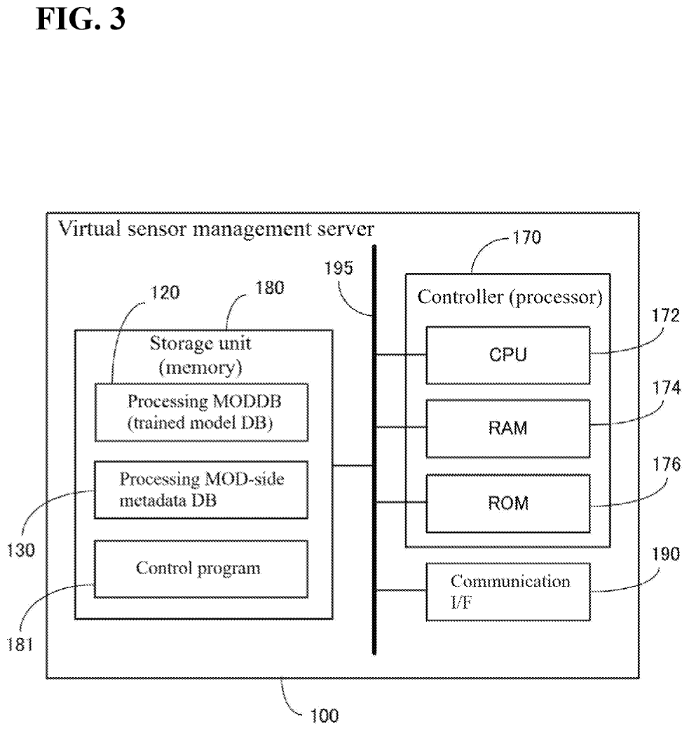

FIG. 3 is a diagram showing an example of a hardware configuration of the virtual sensor management sever 100. Note that in this embodiment, the virtual sensor management server 100 is realized by a general-purpose computer, for example.

In the example shown in FIG. 3, the virtual sensor management server 100 includes a controller 170, a communication I/F (interface) 190, and a storage unit 180, and their constituent elements are electrically connected to each other via a bus 195.

The controller 170 includes a CPU (Central Processing Unit) 172, a RAM (Random Access Memory) 174, a ROM (Read Only Memory) 176, and the like, and is configured to control the constituent elements according to information processing.

The communication I/F 190 is configured to communicate with external apparatuses (e.g., the SDTM server 200, the application servers 300, and the sensor network unit 14 (FIG. 2)) provided outside the virtual sensor management server 100 via the Internet 15. The communication I/F 190 is constituted by a wired LAN (Local Area Network) module or a wireless LAN module, for example.

The storage unit 180 is an auxiliary storage such as a hard disk drive or a solid state drive, for example. The storage unit 180 is configured to store the processing module DB 120, the processing module-side metadata DB (also referred to as “first metadata DB” hereinafter) 130, and a control program 181.

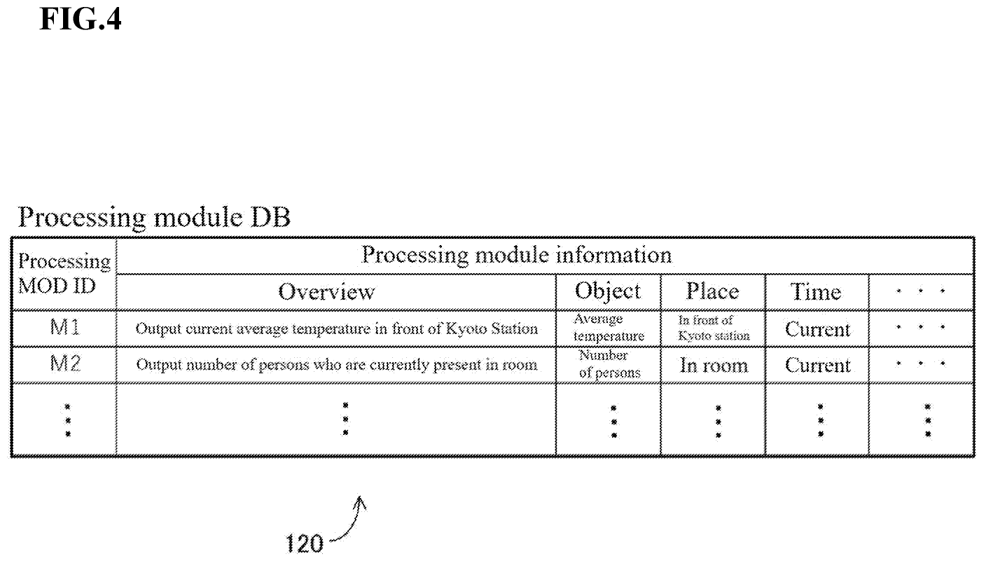

FIG. 4 is a diagram showing an example of the processing module DB 120. Referring to FIG. 4, the processing module DB 120 is a database for managing a plurality of processing modules 121 realized in the virtual sensor management server 100. In the processing module DB 120, “overview”, “object”, “place”, “time”, and the like are managed for each processing module 121. The “overview” indicates an overview of functions of the processing module 121, the “object” indicates an object observed by the processing module 121, the “place” indicates a place observed by the processing module 121, and the “time” indicates the observation timing when the processing module 121 makes an observation, for example. Also, the storage locations of the processing modules 121 are also managed in the processing module DB 120, and the controller 170 can read out the processing modules 121 by accessing the processing module DB 120.

The application server 300 can access the processing module DB 120 via the Internet 15, for example. Thus, a user of an application realized by the application server 300 can select the processing module 121 capable of outputting necessary sensing data from the processing module DB 120, for example.

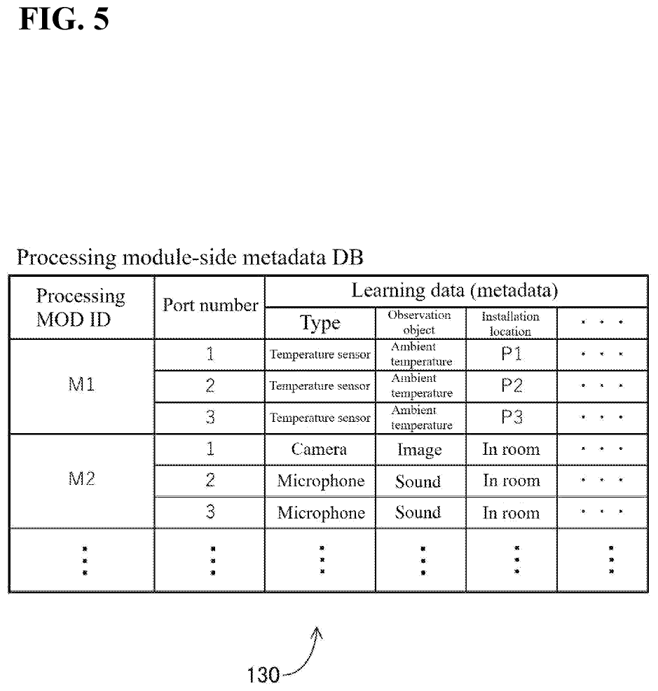

FIG. 5 is a diagram showing an example of the processing module-side metadata DB (first metadata DB) 130. Referring to FIG. 5, the first metadata DB 130 is a database for managing metadata indicating attributes of learning data for training the processing module 121. Learning data is used to train the processing module 121. Metadata of the processing modules 121 realized in the virtual sensor management server 100 are registered in the first metadata DB 130 in advance. Metadata is managed for each input port of the processing modules 121 in the first metadata DB 130.

The processing module-side metadata (the first metadata 131) includes a “type”, an “observation object”, and an “installation location”, for example. The “type” refers to the type of real sensor 12 that has generated learning data, and examples of the “type” include a temperature sensor, a camera, and a microphone. The “observation object” refers to an object observed by the real sensor 12 that has generated learning data, and examples of the “observation object” include an ambient temperature, an image, and sound. The “installation location” refers to the location where the real sensor 12 that has generated learning data is installed, and examples of the “installation location” include P1, P2, P3, and a room (note that P1, P2, and P3 indicate specific places such as “in front of a station”. Note that the attributes of learning data are affected by the attributes of the real sensor 12 that has generated learning data, and thus the attributes of the real sensor 12 are also included in a portion of the attributes of the learning data. The first metadata 131 may also include attributes of data, such as “units” and “the number of digits” of learning data, for example. That is, the attributes of learning data may include the attributes of the real sensor 12 that has generated learning data and the attributes of the learning data.

Referring to FIG. 3 again, the control program 181 is a program for controlling the virtual sensor management server 100 executed by the controller 170. The processing modules 121, the input sensor selection module 110 (FIG. 2), and the like may also be realized as a result of the controller 170 executing the control program 181, for example. When the controller 170 executes the control program 181, the control program 181 is loaded to the RAM 174. Also, the controller 170 controls the constituent elements as a result of the CPU 172 interpreting and executing the control program 181 loaded to the RAM 174. Next, a software module realized by the controller 170 according to the control program 181 will be described.

### 2-3. Software Configuration of Virtual Sensor Management Server

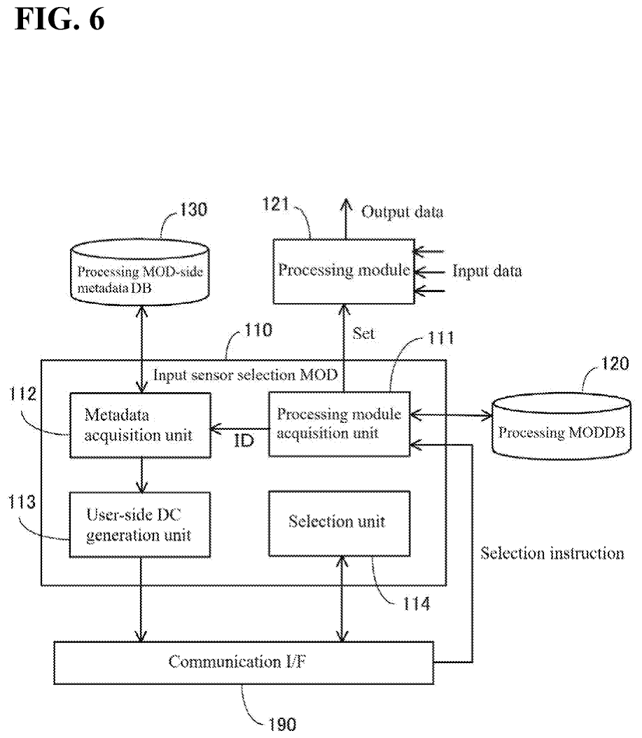

FIG. 6 is a diagram showing an example of a relationship between software modules realized by the controller 170. In the example shown in FIG. 6, the processing module 121 and the input sensor selection module 110 are realized by the controller 170.

As described above, the input sensor selection module 110 is configured to execute processing for selecting a sensor for inputting data to the processing module 121. The input sensor selection module 110 includes a processing module acquisition unit 111, a metadata acquisition unit 112, a user-side DC generation unit 113, and a selection unit 114, for example. Note that the input sensor selection module 110 selects an input sensor for each input port of the processing module 121. Input sensors may be selected in parallel or successively for the input ports. The following description focuses on one input port of the processing module 121.

The processing module acquisition unit 111 acquires one of the plurality of processing modules 121 managed in the processing module DB 120, and sets the acquired processing module 121 as an object for executing processing. The processing module 121 that is set as an object for executing processing executes processing in response to reception of input data. The processing module acquisition unit 111 receives an instruction to select the processing module 121 that is set as an object for executing processing, from the application server 300 (FIG. 2) via the communication I/F 190, and acquires the processing module 121 in accordance with the received selection instruction. Here, the selection instruction is generated in accordance with a user selection of an application realized by the application server 300, for example. This application uses data output from the processing module 121 (data output from a virtual sensor) that is set as an object for executing processing, for example.

The metadata acquisition unit 112 acquires, from the first metadata DB 130, first metadata 131 (FIG. 1) associated with an input port, for which an input sensor is to be selected, of the processing module 121 acquired by the processing module acquisition unit 111.

The user-side DC generation unit 113 generates a user⁻side data catalog based on the first metadata 131 acquired by the metadata acquisition unit 112. The user-side data catalog indicates the attributes of the real sensor 12 required by the user side (the processing module 121). The user-side data catalog includes attributes of learning data for training the processing module 121 indicated by the first metadata 131.

The user-side data catalog generated by the user-side DC generation unit 113 is transmitted to the SDTM server 200 via the communication IF 190. Although details will be described later, a real sensor 12 that has the same attributes as or similar attributes to those indicated in the user-side data catalog is extracted in the SDTM server 200. Information with which the extracted real sensor 12 can be specified (also referred to as “real sensor information” hereinafter) is received via the communication I/F 190. Real sensor information may be an IP address assigned to the real sensor 12 (information indicating the location of the real sensor 12 on the Internet 15), or information indicating the attributes of the real sensor 12, for example.

If real sensor information is received, the selection unit 114 selects one of the real sensors 12. If information regarding a plurality of real sensors has been received, for example, the selection unit 114 selects a real sensor 12 whose attributes are the closest to the attributes indicated in the user-side data catalog. The selection unit 114 transmits a sensor selection command to the SDTM server 200 via the communication I/F 190 such that the selected real sensor 12 starts to output data to the input port of the processing module 121. The sensor selection command will be described later in detail.

Accordingly, data whose attributes are completely different from the attributes of learning data for training the processing module 121 is less likely to be input to the input port of the processing module 121.

### 2-4. Hardware Configuration of SDTM Server

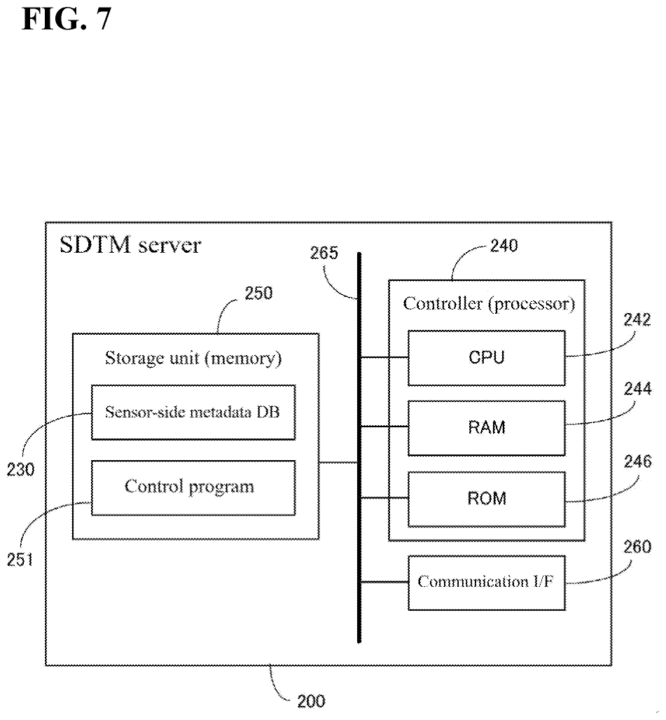

FIG. 7 is a diagram showing an example of a hardware configuration of the SDTM server 200. Note that in this embodiment, the SDTM server 200 is realized by a general-purpose computer, for example.

In the example shown in FIG. 7, the SDTM server 200 includes a controller 240, a communication I/F 260, and a storage unit 250, and their constituent elements are electrically connected to each other via a bus 265.

The controller 240 includes a CPU 242, a RAM 244, a ROM 246, and the like, and is configured to control the constituent elements according to information processing.

The communication I/F 260 is configured to communicate with external apparatuses (e.g., the virtual sensor management server 100, the application server 300, and the sensor network unit 14 (see FIG. 2)) provided outside the SDTM server 200 via the Internet 15. The communication I/F 260 is constituted by a wired LAN module or a wireless LAN module, for example.

The storage unit 250 is an auxiliary storage such as a hard disk drive or a solid state drive, for example. The storage unit 250 is configured to store a sensor-side metadata DB 230 and a control program 251, for example.

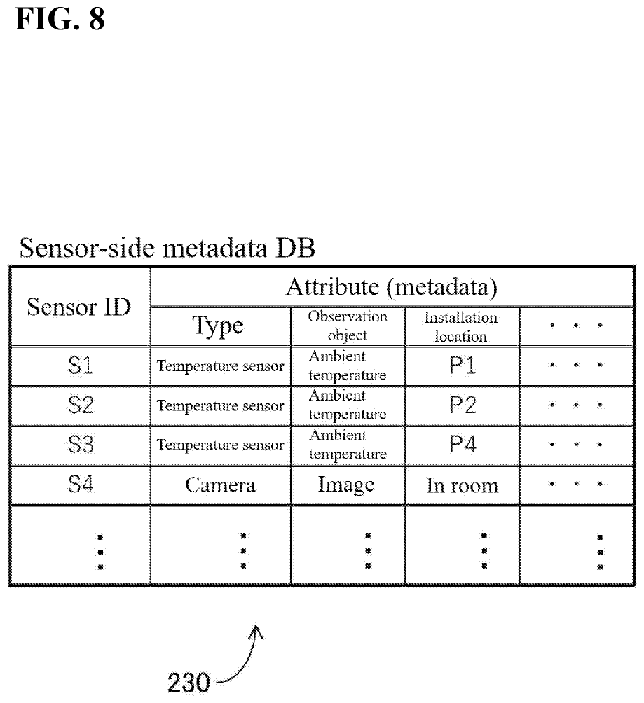

FIG. 8 is a diagram showing an example of the sensor-side metadata DB 230. Referring to FIG. 8, the sensor-side metadata DB 230 is a database for managing metadata indicating the attributes of the real sensors 12 included in the sensor network unit 14 (FIG. 2). Metadata regarding the real sensors 12 included in the sensor network unit 14 is registered in the sensor-side metadata DB 230 in advance. Metadata (the second metadata 13) is managed for each real sensor 12 in the sensor-side metadata DB 230. The sensor-side metadata (second metadata 13) includes attributes of the real sensors 12, such as a “type”, an “observation object”, and an “installation location”, for example. Also, the second metadata 13 may include attributes such as “units” and “the number of digits” of sensing data generated by the real sensors 12, for example. That is, the attributes of the real sensors 12 include attributes of the real sensors 12, and attributes of sensing data generated by the real sensors 12.

Referring to FIG. 7 again, the control program 251 is a program for controlling the SDTM server 200, which is executed by the controller 240. The sensor search module 210 and the data flow control module 220 (FIG. 2) may also be realized as a result of the controller 240 executing the control program 251, for example. When the controller 240 executes the control program 251, the control program 251 is loaded to the RAM 244. Then, the controller 240 controls the constituent elements as a result of the CPU 242 interpreting and executing the control program 251 loaded to the RAM 244. Next, software modules realized by the controller 240 according to the control program 251 will be described.

### 2-5. Software Configuration of SDTM Server

Referring to FIG. 2 again, the sensor search module 210 and the data flow control module 220 are realized by the controller 240 in the SDTM server 200. Hereinafter, each software module will be described in order.

### 2-5-1. Sensor Search Module

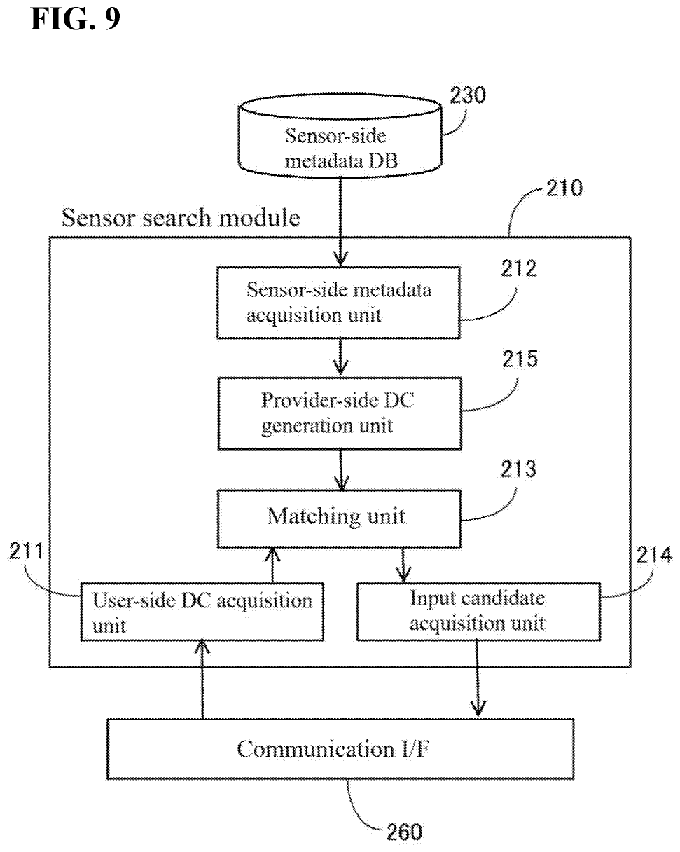

FIG. 9 is a diagram showing an example of a detailed configuration of the sensor search module 210. In the example shown in FIG. 9, the sensor search module 210 includes a user-side data catalog acquisition unit 211, a sensor-side metadata acquisition unit 212, a provider-side data catalog generation unit 215, a matching unit 213, and an input candidate acquisition unit 214.

The user-side data catalog acquisition unit 211 acquires the above-described user-side data catalog from the virtual sensor management server 100 (the input sensor selection module 110) via the communication I/F 260.

The sensor-side metadata acquisition unit 212 acquires the sensor-side metadata 13 (FIG. 1) of the real sensors 12 registered in the sensor-side metadata DB 230 (FIG. 12).

The provider-side data catalog generation unit 215 generates a provider-side data catalog based on the sensor-side metadata 13. A provider-side data catalog is generated for each real sensor 12 registered in the sensor-side metadata DB 230. The provider-side data catalog indicates the attributes on the provider side (the real sensors 12). The provider-side data catalog includes the attributes of the real sensors 12 indicated by the sensor-side metadata 13.

The matching unit 213 performs matching between a user-side data catalog acquired by the user-side data catalog acquisition unit 211 and a provider-side data catalog generated by the provider-side data catalog generation unit 215. Matching is established if attributes of the real sensor 12 included in the provider-side data catalog are the same as or close to attributes of learning data of the processing module 121 included in the user-side data catalog, for example. “Attributes of the real sensor 12 being “close” to attributes of learning data” may also mean that a predetermined percentage or more of a plurality of attributes are the same, or at least important attributes of a plurality of attributes are the same, for example. It may be determined as “close” if, out of a plurality of attributes, at least the attributes of the real sensor 12 are the same, or it may be determined as “close” if, out of a plurality of attributes, at least attributes of data (“units”, “the number of digits”, or the like) are the same, for example. It is predetermined when the relationship “close” is established.

When matching is established, the real sensor 12 corresponding to this provider-side data catalog is extracted as an input sensor candidate for the processing module 121. On the other hand, matching fails if attributes of the real sensor 12 included in the provider-side data catalog are not the same as and are not close to attributes of learning data of the processing module 121 included in the user-side data catalog, for example. When matching fails, the real sensor 12 corresponding to this provider-side data catalog is not extracted as an input sensor candidate.

The input candidate acquisition unit 214 acquires information (real sensor information) with which the real sensor 12 extracted by the matching unit 213 as an input sensor candidate can be specified. The real sensor information acquired by the input candidate acquisition unit 214 is transmitted to the virtual sensor management server 100 (the input sensor selection module 110) via the communication I/F 260.

### 2-5-2. Data Flow Control Module

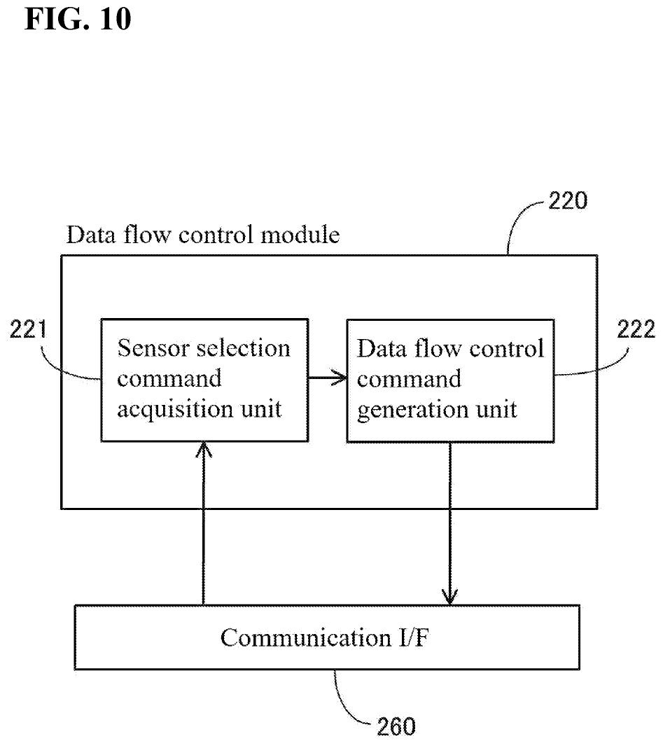

FIG. 10 is a diagram showing an example of a detailed configuration of a data flow control module 220. In the example shown in FIG. 10, the data flow control module 220 includes a sensor selection command acquisition unit 221 and a data flow control command generation unit 222.

The sensor selection command acquisition unit 221 acquires the above-described sensor selection command from the virtual sensor management server 100 (the input sensor selection module 110) via the communication I/F 260. The sensor selection command includes real sensor information regarding the real sensor 12 selected by the input sensor selection module 110 (the selection unit 114).

The data flow control command generation unit 222 generates a data flow control command based on real sensor information regarding the selected real sensor 12. The data flow control command includes a command for the selected real sensor 12 to start to output input data to the processing module 121. The output start command is transmitted to the selected real sensor 12 via the communication I/F 260. When the real sensor 12 permits outputting sensing data if the output start command has been received, for example, the real sensor 12 transmits, to the virtual sensor management server 100, an API (Application Programming Interface) for establishing communication with the processing module 121 to which the sensing data is output. In the virtual sensor management server 100, when this API is executed, the real sensor 12 that has received the output start command starts to output sensing data to the processing module 121 to which sensing data is to be output.

### 3. Operation

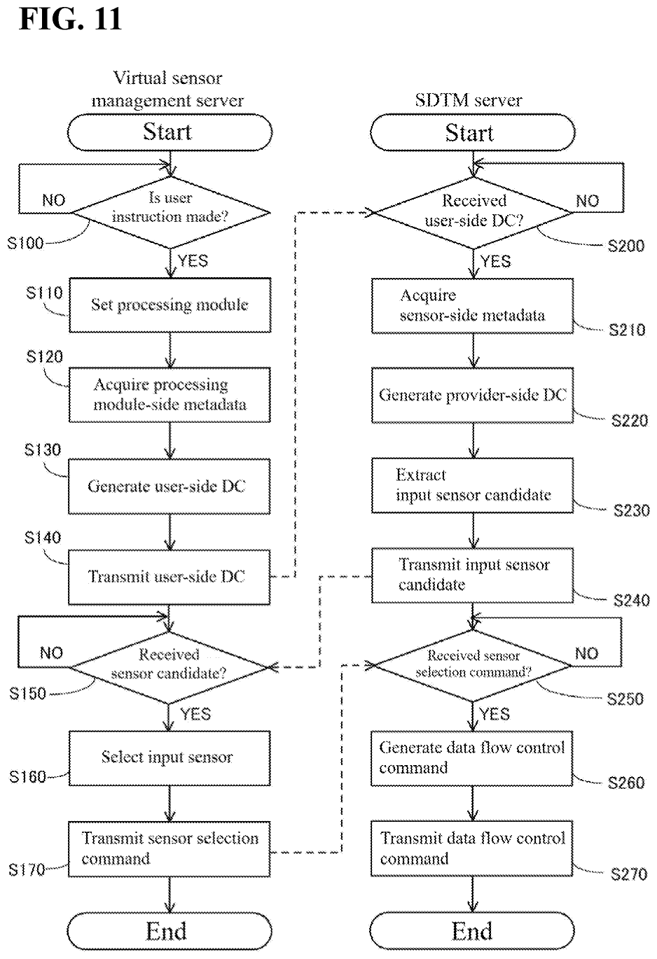

FIG. 11 is a flowchart showing an example of an input sensor selection operation of the processing module 121. Processing indicated in this flowchart is executed if a user selects the processing module 121 via an application realized by the application server 300, for example. Note that, as described above, although an input sensor is selected for each input port of the processing modules 121, the following description focuses on one input port of one processing module 121 here.

Referring to FIG. 11, the left flowchart is executed as a result of the controller 170 operating as the input sensor selection module 110. On the other hand, the right flowchart is executed as a result of the controller 240 operating as the sensor search module 210.

Referring to the left flowchart in FIG. 11, the controller 170 determines whether or not an instruction for selecting the processing module 121 has been received from a user via the application server 300 (step S100). If it is determined that the selection instruction is not received (NO in step S100), the controller 170 waits until the selection instruction is received.

On the other hand, if it is determined that the selection instruction has been received (YES in step S100), the controller 170 acquires the processing module 121 indicated in the selection instruction by referencing the processing module DB 120, and sets the acquired processing module 121 as the module to be executed (step S110).

The controller 170 acquires, from the first metadata DB 130 (FIG. 5), the first metadata 131 associated with the input port of the processing module 121 that is set as the module to be executed (step S120). The controller 170 generates a user-side data catalog based on the acquired first metadata 131 (step S130).

The controller 170 controls the communication I/F 190 to transmit the generated user-side data catalog to the SDTM server 200 (step S140). Then, the controller 170 determines whether information indicating an input sensor candidate (real sensor information) has been received from the SDTM server 200 via the communication I/F 190 (step S150). If it is determined that no real sensor information has been received (NO in step S150), the controller 170 waits until real sensor information is received.

Referring to the right flowchart in FIG. 11, the controller 240 determines whether or not a user-side data catalog has been received (step S200). If it is determined that no user-side data catalog has been received (NO in step S200), the controller 240 waits until a user-side data catalog is received.

If it is determined that a user-side data catalog has been received (YES in step S200), the controller 240 acquires sensor-side metadata 13 regarding the real sensors 12 managed in the sensor-side metadata DB 230 (step S210). The controller 240 generates a provider-side data catalog based on the acquired sensor-side metadata 13 (step S220).

The controller 240 extracts input sensor candidates from a plurality of real sensors 12 managed by the sensor-side metadata DB 230 based on the acquired user-side data catalog and the generated provider-side data catalog (step S230).

If attributes indicated by the provider-side data catalog are the same as or are close to attributes indicated by the user-side data catalog, for example, the controller 240 extracts the real sensor 12 corresponding to this provider-side data catalog, as an input sensor candidate.

The controller 240 controls the communication I/F 260 to transmit the real sensor information with which the extracted real sensor 12 can be specified to the virtual sensor management server 100 (step S240).

Referring to the left flowchart in FIG. 11 again, when real sensor information (information indicating an input sensor candidate) is received in step S150 (YES in step S150), the controller 170 selects one of the real sensors 12 indicated in the received real sensor information according to a predetermined standard (step S160).

In order to make the selected real sensor 12 start outputting data to the input port of the processing module 121, the controller 170 controls the communication I/F 190 to transmit a sensor selection command to the SDTM server 200 (step S170). The sensor selection command includes real sensor information with which the selected real sensor 12 can be specified, for example.

Referring to the right flowchart in FIG. 11 again, the controller 240 determines whether or not a sensor selection command has been received from the virtual sensor management server 100 via the communication I/F 260 (step S250). If it is determined that no sensor selection command has been received (NO in step S250), the controller 240 waits until the sensor selection command is received.

On the other hand, if it is determined that a sensor selection command has been received (YES in step S250), the controller 240 generates the above-described data flow control command (step S260). The controller 240 transmits the generated data flow control command to the selected real sensor 12 and the virtual sensor management server 100 (step S520). Accordingly, the selected real sensor 12 starts to output sensing data to the processing module 121.

### 4. Features

As described above, in this embodiment, the controllers 170 and 240 select the real sensor 12 for outputting input data to the processing module 121 based on the first metadata 131 and the second metadata 13. As described above, the processing module 121 is a trained model generated using a plurality of learning data. A trained model assumes attributes of learning data, and thus does not always output a desired result if data sets with completely different attributes are input. In this embodiment, when the real sensor 12 for outputting input data to the processing module 121 is selected, first metadata 131 indicating attributes of learning data and second metadata 13 indicating attributes of input data output by the real sensor 12 are taken into account. Thus, according to this embodiment, it is possible to select an input sensor as appropriate because a sensor for inputting data to the processing module 121 is selected in consideration of attributes of learning data.

More specifically, in this embodiment, the controllers 170 and 240 select, as a sensor for inputting data to the processing module 121, the real sensor 12 for outputting input data whose attributes are the same as or close to those of learning data used to train the processing module 121. Thus, according to this embodiment, it is possible to prevent a situation where a virtual sensor cannot exhibit its desired function because the real sensor 12 that outputs data with attributes that are completely different from the attributes of learning data is not selected as an input sensor.

Note that the processing module 121 is an example of a “processing module” according to the present invention, the real sensor 12 is an example of a “device” according to the present invention, the processing module-side metadata 131 is an example of “first metadata” according to the present invention, and the sensor-side metadata 13 is an example of “second metadata” according to the present invention. A configuration including the input sensor selection module 110 and the sensor search module 210, and the sensor selection apparatus 50 are examples of a “device selection apparatus” according to the present invention. The metadata acquisition unit 112 is an example of the “first acquisition unit” according to the present invention, the sensor-side metadata acquisition unit 212 is an example of the “second acquisition unit” according to the present invention, and a configuration including the matching unit 213 and the selection unit 114 is an example of the “selection unit” according to the present invention. Also, the processing module acquisition unit 111 is an example of the “third acquisition unit” according to the present invention, and the processing module DB 120 is an example of a “database” according to the present invention.

### 5. Modifications

Although an embodiment has been described above, the present invention is not limited to the above-described embodiment, and various modifications can be made without departing from its spirit. The following describes modifications.

However, the following modifications can be combined as appropriate.

5-1

A sensor for inputting data to the processing module 121 is selected in the above-described embodiment. However, an object to be selected is not necessarily a sensor for inputting data to the processing module 121. A data set that is input to the processing module 121 may also be selected, for example. A data set is a set of pre-generated data. An example of a data set is sensing data obtained by observing a subject for a predetermined period of time in advance, for example. A “data set” is stored in a storage connected to the Internet 15, for example.

In this case, metadata indicating attributes of the data sets are managed in the SDTM server 200, for example. A provider-side data catalog is generated based on the metadata associated with the data sets. Also, a data set is extracted that includes data having attributes that are the same as or close to the attributes of learning data used to train the processing module 121 based on a user-side data catalog and the provider-side data catalog. That is, a data set to be input to an input port of the processing module 121 is extracted from a plurality of data sets based on first metadata (processing module-side metadata) 131 and metadata associated with the data sets. Accordingly, it is possible to extract an appropriate data set that includes data whose attributes are the same as or close to the attributes of learning data to train the processing module 121.

Objects selected as input sensors for the processing module 121 may also include both the real sensors 12 and the data sets.

5-2

Also, in the above-described embodiment, it is assumed that the input ports of the processing modules 121 receive data input by the real sensors 12. However, input ports receive data not only from the real sensors 12. Input ports may also receive data input by a storage with data sets stored, or receive data input by a virtual sensor. Because a sensor does not necessarily mainly output input data, data that is input to the processing module 121 does not necessarily have to be sensing data. Examples of input data include purchase history data regarding users on a shopping site and score data regarding users on a game site.

5-3

Processing performed by the virtual sensor management server 100 and the SDTM server 200 in the above-described embodiment may also be realized by a plurality of servers or the like. Also, processing performed by the virtual sensor management server 100 and the SDTM server 200 may also be realized by one server or the like in the above-described embodiment.

### INDEX TO THE REFERENCE NUMERALS

10 Sensor network system

11 Sensor network adapter

12 Real sensor

13 Sensor-side metadata (second metadata)

14 Sensor network unit

15 Internet

50 Sensor selection apparatus

100 Virtual sensor management server

110 Input sensor selection module

111 Processing module acquisition unit

112 Metadata acquisition unit

113 User-side DC generation unit

114 Selection unit

120 Processing module DB

121 Processing module

130 Processing module-side metadata DB (first metadata DB)

131 Processing module-side metadata (first metadata)

170, 240 Controller

172, 242 CPU

174, 244 RAM

176, 246 ROM

180, 250 Storage unit

181, 251 Control program

190, 260 Communication I/F

195, 265 Bus

200 SDTM server

210 Sensor search module

211 User-side data catalog acquisition unit

212 Sensor-side metadata acquisition unit

213 Matching unit

214 Input candidate acquisition unit

215 Provider-side data catalog generation unit

220 Data flow control module

221 Sensor selection command acquisition unit

222 Data flow control command generation unit

230 Sensor-side metadata DB (second metadata DB)

300 Application server

1. A device selection apparatus configured to select a device for outputting input data to a processing module,
wherein the processing module is a trained model generated using a plurality of learning data, and is configured to generate, based on at least one of the input data, output data that is different from the input data,
the processing module is associated with first metadata indicating an attribute of the learning data,
the device is associated with second metadata indicating an attribute of input data output by the device,
the device selection apparatus comprises:
a first acquisition unit configured to acquire the first metadata;
a second acquisition unit configured to acquire the second metadata associated with a plurality of devices; and
a selection unit configured to select, from the plurality of devices, a device for outputting input data to the processing module based on the first metadata and the second metadata.

2. The device selection apparatus according to claim 1, further comprising:
a third acquisition unit configured to acquire one of a plurality of processing modules from a database in which the processing modules are stored,
wherein the first acquisition unit is configured to acquire the first metadata associated with the processing module acquired by the third acquisition unit.

3. The device selection apparatus according to claim 1 or 2,
wherein the third acquisition unit is configured to acquire the processing module from the database in accordance with a user instruction.

4. The device selection apparatus according to any one of claims 1 to 3,
wherein the device is a sensor, and
the input data is sensing data generated by the sensor.

5. The device selection apparatus according to any one of claims 1 to 4,
wherein the processing module is configured to generate the output data based on a plurality of the input data.

6. The device selection apparatus according to any one of claims 1 to 5,
wherein the processing module is configured to be capable of switching the device for outputting the input data to the processing module.

7. The device selection apparatus according to any one of claims 1 to 6,
wherein a virtual sensor is formed by the processing module and the device for outputting the input data to the processing module.

8. A data set selection apparatus configured to select a data set to be input to a processing module,
wherein the data set is constituted by a plurality of data,
the processing module is a trained model generated using a plurality of learning data, and is configured to generate, based on at least one of the input data, output data that is different from the input data,
the processing module is associated with first metadata indicating an attribute of the learning data,
the data set is associated with second metadata indicating an attribute of the data set,
the data set selection apparatus comprises:
a first acquisition unit configured to acquire the first metadata;
a second acquisition unit configured to acquire the second metadata associated with a plurality of data sets; and
a selection unit configured to select, from the plurality of data sets, a data set to be input to the processing module based on the first metadata and the second metadata.

9. A method for selecting a device for outputting input data to a processing module,
wherein the processing module is a trained model generated using a plurality of learning data, and is configured to generate output data that is different from the input data based on at least one of the input data,
the processing module is associated with first metadata indicating an attribute of the learning data,
the device is associated with second metadata indicating an attribute of input data output by the device,
the selection method comprises:
a step of acquiring the first metadata;
a step of acquiring the second metadata associated with a plurality of devices; and
a step of selecting, from the plurality of devices, a device for outputting input data to the processing module based on the first metadata and the second metadata.

10. A program for causing a computer to execute processing for selecting a device for outputting input data to a processing module,
wherein the processing module is a trained model generated using a plurality of learning data, and is configured to generate output data that is different from the input data based on at least one of the input data,
the processing module is associated with first metadata indicating an attribute of the learning data,
the device is associated with second metadata indicating an attribute of input data output by the device,
the program is configured to cause the computer to execute:
a step of acquiring the first metadata;
a step of acquiring the second metadata associated with a plurality of devices; and
a step of selecting, from the plurality of devices, a device for outputting input data to the processing module based on the first metadata and the second metadata.
